(19) United States
(12) Patent Application Publication
(10) Pub. No.: US 2021/0081758 A1
(43) Pub. Date: Mar. 18, 2021

(54) SYSTEM AND METHOD FOR A RECOMMENDER

(71) Applicant: International Business Machines Corporation, Armonk, NY (US)

(72) Inventors: Alexander Zadorojniy, HAIFA (IL); Michael Masin, HAIFA (IL); Evgeny Shindin, Nesher (IL); Nir Mashkif, Ein Carmel (IL)

(21) Appl. No.: 16/568,292

(22) Filed: Sep. 12, 2019

(51) Int. Cl. G06N 3/04; G06N 3/08

(52) U.S. Cl. CPC G06N 3/0427; G06N 3/08

(57) ABSTRACT

A method for predicting at least one score for at least one item, comprising in at least one iteration of a plurality of iterations: receiving a user profile having a plurality of user attribute values; computing the at least one score according to a similarity between the user profile and a plurality of other user profiles by inputting the user profile and a plurality of items into a prediction model trained by: in each of a plurality of training iterations: receiving a training user profile of a plurality of training user profiles, the training user profile having a plurality of training user attribute values; computing by the prediction model a plurality of predicted scores, each for one of a plurality of training items, in response to the training user profile and the plurality of training items, where each of the plurality of training items has a plurality of training item.

### BACKGROUND

The present invention, in some embodiments thereof, relates to a prediction system and, more specifically, but not exclusively, to a recommender system.

For brevity, henceforth the term “recommender” is used to mean a recommender system, and the terms are used interchangeably.

A recommender system is a system for predicting a rating, or a score a user would give to an item, indicative of the user's preference for the item. Some areas where recommender systems are used are generation of content playlists, for example digital music and video, services that recommend products, for example commercial consumer products, movies, hotels and restaurants, content recommendation for social media platforms, online dating services, and financial services.

Some existing approaches to recommender systems focus on recommending the most relevant item or items to a user using contextual information. Currently, recommenders are mostly problem driven, each adapted to an identified domain and sometimes to an identified customer in a given domain. For example, a recommender for generating a music playlist may not be suitable as is to recommend restaurants. Moreover, a recommender for generating a music playlist may not be suitable as is to recommend a movie playlist. For an identified problem in an identified domain, there is a need to adapt a recommender to the identified problem in the identified domain.

### SUMMARY

It is an object of the present invention to provide a system and a method for training and using a recommender.

The foregoing and other objects are achieved by the features of the independent claims. Further implementation forms are apparent from the dependent claims, the description and the figures.

According to a first aspect of the invention, a method for predicting at least one score for at least one item comprises: in at least one iteration of a plurality of iterations: receiving a user profile having a plurality of user attribute values; computing the at least one score according to a similarity between the user profile and a plurality of other user profiles by inputting the user profile and a plurality of items into a prediction model trained by: in each of a plurality of training iterations: receiving a training user profile of a plurality of training user profiles, the training user profile having a plurality of training user attribute values; computing by the prediction model a plurality of predicted scores, each for one of a plurality of training items, in response to the training user profile and the plurality of training items, where each of the plurality of training items has a plurality of training item properties; computing for the training user profile a plurality of expected scores, each computed for one of the plurality of training items according to the plurality of training user attribute values and the plurality of training item properties of the training item; and modifying at least one model value of a plurality of model values of the prediction model to maximize a reward score computed using the plurality of expected scores and the plurality of predicted scores; and outputting the at least one score.

According to a second aspect of the invention, a system for predicting at least one score for at least one item comprises at least one hardware processor adapted to: in at least one iteration of a plurality of iterations: receiving a user profile having a plurality of user attribute values; computing the at least one score according to a similarity between the user profile and a plurality of other user profiles by inputting the user profile and a plurality of items into a prediction model trained by: in each of a plurality of training iterations: receiving a training user profile of a plurality of training user profiles, the training user profile having a plurality of training user attribute values; computing by the prediction model a plurality of predicted scores, each for one of a plurality of training items, in response to the training user profile and the plurality of training items, where each of the plurality of training items has a plurality of training item properties; computing for the training user profile a plurality of expected scores, each computed for one of the plurality of training items according to the plurality of training user attribute values and the plurality of training item properties of the training item; and modifying at least one model value of a plurality of model values of the prediction model to maximize a reward score computed using the plurality of expected scores and the plurality of predicted scores; and outputting the at least one score.

According to a third aspect of the invention, a system for training a prediction model comprises at least one hardware processor adapted to: in each of a plurality of training iterations: receiving a training user profile of a plurality of training user profiles, the training user profile having a plurality of training user attribute values; computing by the prediction model a plurality of predicted scores, each for one of a plurality of training items, in response to the training user profile and the plurality of training items, where each of the plurality of training items has a plurality of training item properties; computing for the training user profile a plurality of expected scores, each computed for one of the plurality of training items according to the plurality of training user attribute values and the plurality of training item properties of the training item; and modifying at least one model value of a plurality of model values of the prediction model to maximize a reward score computed using the plurality of expected scores and the plurality of predicted scores.

With reference to the first and second aspects, in a first possible implementation of the first and second aspects of the present invention the similarity between the user profile and the plurality of other user profiles is computed according to a similarity between the plurality of user attribute values and another plurality of user attribute values of the plurality of other user profiles. Using a user profile with user attributes to describe the user facilitates identifying the similarity between the user profile and other user profiles, thus increasing accuracy of an output of the prediction model. Optionally, the plurality of user attribute values comprises at least one of: a user demographic value, a user preference value, a user identifier value, and a historical user interaction value. Optionally, the historical user interaction value is indicative of a user interaction selected from a group of user interactions consisting of: a numerical score assigned by a user, a like indication, a purchase, a bookmarked item, and a skipped item. Optionally, at least one of the plurality of items is selected from a group of items consisting of: a restaurant identifier, a hospitality facility identifier, a movie identifier, a book identifier, a consumer appliance identifier, a retailer identifier, and a venue identifier.

With reference to the first and second aspects, in a second possible implementation of the first and second aspects of the present invention the prediction model comprises at least one deep reinforcement learning (DRL) network. Using a DRL network increases accuracy of an output of the prediction model.

With reference to the first and second aspects, in a third possible implementation of the first and second aspects of the present invention computing the plurality of expected scores comprises applying a content based filtering method to the plurality of training user attribute values and a plurality of training item properties of the plurality of training items. Using content based filtering to compute the plurality of expected scores expedites training of the prediction model and thus reduces cost of implementation of a prediction system using the prediction model. Optionally, applying the content based filtering method comprises providing the plurality of training user attribute values and the plurality of training item properties to at least one neural network. Using one or more neural networks for the content base filtering increases accuracy of the plurality of expected scores.

With reference to the first and second aspects, in a fourth possible implementation of the first and second aspects of the present invention training the prediction model comprises using a Q-learning method having a state, a plurality of actions, a reward and an output. Optionally, the state is a vector of state values indicative of a plurality of training user attribute values of the training user profile. Optionally, the plurality of actions is a plurality of vectors of item values, each vector of item values indicative of a respective plurality of training item properties of one of the plurality of training items. Optionally, the reward is the plurality of expected scores. Optionally, the output is the plurality of predicted scores. Optionally, the Q-learning method has another state, another plurality of actions, another reward and another output. Optionally, the other state is a vector of state values indicative of another plurality of training user attribute values of the training user profile and another plurality of training item properties of the plurality of training items. Optionally, the plurality of actions is another plurality of vectors of item values, each vector of item values indicative of a respective plurality of training item properties of one of the plurality of training items. Optionally, the reward is one of the plurality of expected scores. Optionally, the output is a predicted score computed for one of the plurality of training user profiles and one of the plurality of training items in at least one of the plurality of training iterations. Using a Q-learning method to train the prediction model allows considering a long-term impact of an immediate benefit (reward) of a recommendation, thus increasing accuracy of an output of the prediction model. With reference to the first and second aspects, in a fifth possible implementation of the first and second aspects of the present invention training the prediction model further comprises: collecting at least one feedback value from at least one training user associated with at least one of the plurality of training user profiles, where the at least one feedback value is indicative of a level of agreement of the at least one user with at least some of the plurality of predicted scores computed by the prediction model in response to the respective training user profile and the plurality of training items; and updating at least one training user attribute value of the respective at least one training user profile according to the at least one feedback value. Updating a training user attribute value according to a feedback value, indicative of a level of agreement of a user with one or more predicted scores computed by the prediction model, increases accuracy of an output of the prediction model.

With reference to the first and second aspects, in a sixth possible implementation of the first and second aspects of the present invention outputting the at least one score comprises outputting for each of the at least one score a respective item of the at least one item. Outputting the item allows using the prediction model in a recommendation system providing one or more item recommendations to a user.

With reference to the first and second aspects, in a seventh possible implementation of the first and second aspects of the present invention inputting the user profile and the plurality of items into a prediction model comprises computing at least one set of state values indicative of the plurality of user attribute values and a plurality of item properties of the plurality of items. Using a set of state values facilitates training the prediction model using a state based method such as Q learning.

With reference to the first and second aspects, in an eighth possible implementation of the first and second aspects of the present invention computing the at least one score further comprises: computing at least one other score, each computed for one of the plurality of items according to the plurality of user attribute values and the respective plurality of item properties of the respective item; and aggregating the at least one score with the at least one other score. Optionally, computing the at least one other score comprises applying a content based filtering method to the plurality of user attribute values and a plurality of item properties of the plurality of items. Combining another score computed according to user attributes and item properties with a predicted score computed according to a similarity between the user profile and a plurality of other user profiles increases accuracy of an output of the prediction model.

With reference to the first and second aspects, or the first implementation of the first and second aspects, in a ninth possible implementation of the first and second aspects of the present invention computing the at least one score further comprises: computing at least one collaborative filtering score, each computed for one of the plurality of items according to another similarity between the plurality of user attribute values and the other plurality of user attribute values of the plurality of other user profiles, by applying at least one matrix factorization method to the plurality of item properties, the plurality of user attribute values and the other plurality of user attribute values; and aggregating the at least one score with the at least one collaborative filtering score. Using matrix factorization expedites computing the at least one other score, thus increasing throughput of the prediction model.

With reference to the first and second aspects, in a tenth possible implementation of the first and second aspects of the present invention computing the at least one score further comprises: identifying at least one highest score of the at least one score; and outputting the at least one highest score. Optionally, computing the at least one score further comprises: computing at least one filtered score by applying at least one test to the at least one score; and outputting the at least one filtered score. Applying one or more tests and additionally or alternatively identifying one or more highest scores increases accuracy of an output of the prediction model.

With reference to the first and second aspects, in an eleventh possible implementation of the first and second aspects of the present invention the at least one hardware processor is adapted to outputting the at least one score via at least one digital communication network interface connected to the at least one hardware processor. Optionally, the at least one hardware processor is adapted to receiving the user profile by at least one of: receiving the user profile via the at least one digital communication network interface connected to the at least one hardware processor, and retrieving the user profile from at least one non-volatile digital storage connected to the at least one hardware processor.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic block diagram of an exemplary system for training, according to some embodiments of the present invention;

FIG. 2 is a flowchart schematically representing an optional flow of operations for training, according to some embodiments of the present invention;

FIG. 3 is a schematic block diagram of an exemplary system for predicting, according to some embodiments of the present invention; and

FIG. 4 is a flowchart schematically representing an optional flow of operations for predicting, according to some embodiments of the present invention.

### DETAILED DESCRIPTION

The present invention, in some embodiments thereof, relates to a prediction system and, more specifically, but not exclusively, to a recommender system.

A recommender predicts one or more scores a user would give to one or more items. A user has a user profile, describing the user. Some user profiles have a plurality of user attribute values, each for one of a plurality of user attributes describing the user. A user profile may include demographic information, some example being age, address, occupation, and physical properties such as height and weight. A user profile may include a user preference, some examples being a preference for mild food, a preference for rock music and a preference for boutique hotels. A user preference may be learned by a recommender explicitly, from a response to a question the user answers. A user preference may be inferred, for example from other user preferences. A user profile may include historical user interaction values, for example a score, such as a numerical score, assigned by the user to an item. Other examples of a historical user interaction are an indication on social media, such as a like indication, a purchase of one or more items, viewing or listening to an item, a bookmarked item and a skipped item, for example when the user views one or more suggested items. Additional examples of a historical user interaction are an amount of time a user views an item and duration of time a user views an item. A user preference may be inferred from one or more historical user interaction values. A plurality of user attribute values of a user in a first identified domain may be different from another plurality of user attribute values of the user in a second identified domain. For example, in the first identified domain, the plurality of user attribute values may comprise a preference for carbonated beverages, where in the second identified domain the other plurality of user attribute values may have no value indicating a beverage preference.

As used in this disclosure, an item is an object of a recommendation. Some examples of an item are a music file, a video file, a name of a movie, a restaurant, a book, a hotel, a consumer product such as a car, an item of clothing, or a washing machine, an event such as a movie screening, a concert, a party, or a lecture, a person, such as a potential romantic match or a potential professional collaborator, a financial investment, and a life insurance policy. An item may be described by a plurality of item properties. The plurality of item properties may depend on a domain in which the recommender is used. A first plurality of item properties describing a book may include a price, an amount of pages, an age classification, a genre, and a publisher identifier. A second plurality of item properties describing a hotel may include a price range, location and availability. A third plurality of item properties describing a washing machine my include capacity, electrical specification information and dimension information.

One existing approach to designing a recommender is content-based filtering (CBF). Content-based filtering methods are based on item properties and the user's user profile attribute values. Existing CBF recommenders learn about a user's preferences from interaction with the user, either by explicit input from the user or by inference from interaction with the user. Some CBF recommenders are limited to learning about a user's preferences from interaction with the user regarding one or more identified types of items, and thus tend to be limited to recommending items of a type similar to those that a user liked in the past or is currently examining. For example, a movie recommendation may be more accurate when taking in to account a user's preferences for music; however a system recommending a movie may not have information about a user's previous selection of music.

Another existing approach to designing a recommender is collaborative filtering (CF), where a user's score for an item is predicted according to a similarity between the user and a group of users. Such a prediction is based on an underlying assumption that two users sharing a preference regarding a first issue also share a preference regarding a second issue. For example, two users having similar preferences regarding movies are assumed to have, for the purpose of collaborative filtering, similar preferences regarding television programs. Some collaborative filtering recommenders use one or more prediction models, for example one or more neural networks, to predict one or more scores for one or more items. Some collaborative filtering recommenders use one or more matrix factorization methods, where interactions between users and items are represented in an interaction matrix and the interaction matrix is decomposed into a product of two lower dimensionality rectangular matrices.

In a CF recommender, for a new item there may not be enough data to make an accurate recommendation. This is also known as the cold start problem. Furthermore, fitting a recommender for a new domain, or for a new problem within an existing domain, is a lengthy and expensive process, while data is collected.

The term deep learning, as used herein, refers to a class of machine learning models that use multiple computation layers to progressively extract higher level features from raw input. Some examples of a deep learning model are a convolutional neural network, a deep neural network, and a deep believe network. The term reinforcement learning, as used herein, refers to a class of machine learning methods where a machine learning model interacts with an environment in multiple steps, choosing at each step an action to apply to the environment and receiving a reward indicative of a similarity between an outcome of applying the chosen action to the environment and applying a known optimal action to the environment. Alternatively, the model may receive a penalty (loss), indicative of a distance between the outcome of applying the chosen action to the environment and applying the known optimal action to the environment. In reinforcement learning, at each step, one or more model values of a machine learning model are modified to maximize a reward (or minimize a loss) in a future step. Some examples of a reinforcement learning method are actor critic and Q-learning.

As used herein, the term deep reinforcement learning (DRL) refers to methods that apply one or more reinforcement learning methods to one or more deep learning models. A DRL network is a neural network trained using DRL. As used herein, The term “DRL recommender” refers to a recommendation system trained using one or more DRL methods.

The present invention proposes, in some embodiments thereof, training a DRL recommender for collaborative filtering using a reward based on scores computed by a content-based filtering recommender. Optionally, the DRL recommender for collaborative filtering is a prediction model trained to compute for a user one or more scores for one or more items according to a similarity between the user's user profile and a plurality of other training user profiles. In such embodiments, the prediction model is trained using one or more reinforcement learning methods where a reward score is computed using a plurality of expected scores, each computed based on a training user's profile and a plurality of training item properties of one or more training items. Using expected scores computed based on the training user's profile and the plurality of training item properties of the one or more training items facilitates training the prediction model when there is little data collected about a user's preferences with regards to the one or more items, reducing cost of training the prediction model and an amount of time required to train the prediction model while at the same time increasing accuracy of an output of the prediction model. Optionally, the one or more expected scores are computed using a content-based filtering method, for example a statistical method. Another example of a content-based filtering method is a rule based method. Optionally, the one or more expected scores are computed using one or more machine learning methods, for example a decision tree. Another example of a machine learning method is using one or more neural networks. Optionally, the prediction model is a deep reinforcement learning model. Optionally, the prediction model is trained using a Q-learning method, maximizing an expected value of a total reward over any and all successive actions (steps), starting from a current state. Using a Q-learning method to train the prediction model allows considering a long-term impact of an immediate benefit (reward) of a recommendation, thus increasing accuracy of an output of the prediction model.

In addition, the present invention proposes, in some embodiments thereof, collecting one or more feedback values from the one or more training users associated with one or more training user profiles used to train the prediction model. Optionally, the one or more feedback values are indicative of a level of agreement of the one or more training users with at least some of the one or more predicted scores. Optionally, one or more training user attribute values of the respective one or more training users are updated according to the one or more feedback values. Updating the one or more training user attribute values according to the one or more feedback values increases accuracy of an output of the prediction model.

In addition, in some embodiments, the present invention proposes computing for a user one or more scores for one or more items using a prediction model trained according to the present invention. Optionally, the present invention proposes computing the one or more scores using a combination of collaborative filtering, computed according to the present invention, and content-based filtering. In such embodiments, one or more other scores are each computed for one of the one or more items according a plurality of user attribute values of the user and a respective plurality of the item properties of the respective item. Optionally, each of the one or more scores is aggregated with the respective one or more other scores. Optionally, the one or more other scores are computed using a content-based filtering method, applied to the plurality of user attribute values and the plurality of item properties. Using a hybrid of content-based filtering and collaborative filtering to compute the one or more scores increases accuracy of an output of the prediction model.

In addition, the present invention proposes, in some embodiments thereof, filtering the one or more scores before outputting the one or more scores according to one or more tests applied to the out or more scores. For example, in some embodiments only an identified amount of highest scores are output. Optionally, applying a test to the score comprises applying the test to the respective item. Some other examples of a test are a restriction on an item's location, a dietary restriction, a price range, an age classification, and an item's availability by date. Applying one or more tests to the one or more scores increases accuracy of an output of the prediction model.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

For brevity, henceforth the term “processor” is used to mean “at least one hardware processor” and the terms are used interchangeably.

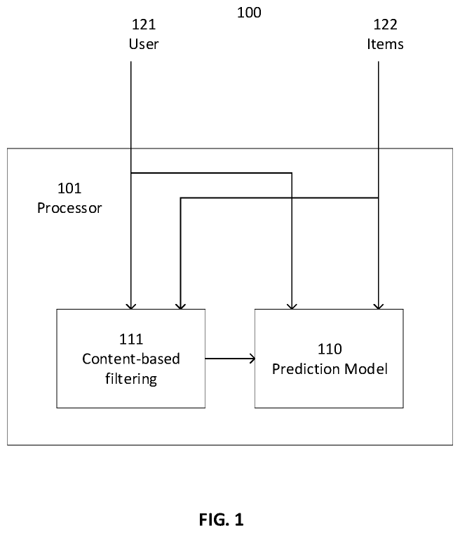

Reference is now made to FIG. 1, showing a schematic block diagram of an exemplary system 100 for training, according to some embodiments of the present invention. In such embodiments, at least one hardware processor 101 executes one prediction model 110, for the purpose of training prediction model 110. Optionally, the prediction model comprises at least one neural network. Optionally, the at least one neural network is at least one deep reinforcement learning neural network. Optionally, processor 101 executes at least one software object 111 for the purpose of computing one or more expected scores, each for one of a plurality of training items according to a plurality of training user attribute values 121 of a training user and a plurality of training item properties 122 of one or more training items.

To train prediction model 110 system 100 implements, in some embodiments of the present invention, the following optional method.

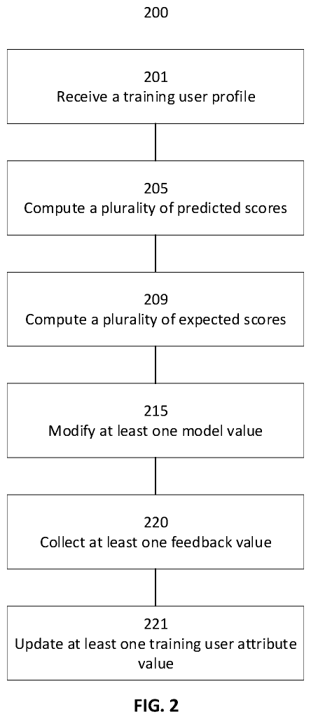

Reference is now made to FIG. 2, showing a flowchart schematically representing an optional flow of operations 200 for training, according to some embodiments of the present invention. In such embodiments, in 201 processor 101 receives a training user profile, optionally one of a plurality of training user profiles. Optionally, the training user profile has a plurality of training user attribute values describing a training user, for example plurality of user attribute values 121. Optionally, plurality of training user attribute values 121 comprises one or more user demographic values, for example an age value and an address value. Optionally, plurality of training user attribute values 121 comprises one or more user preference values, for example a musical genre and book title. Optionally, plurality of training user attribute values 121 comprises one or more historical interaction values, for example a like indication in social media and a bookmarked consumer product. Optionally, a historical interaction value is implicit, for example an amount of time a user browsed an item. Other examples of a historical interaction value are a numerical score assigned by a user, for example for an item, a purchase, for example of an item, and a skipped item. Optionally, plurality of training user attribute values 121 comprises one or more user identifier values, for example a user identifier of a social contact in social media. In 205, processor 101 optionally computes a plurality of predicted scores, each for one of a plurality of training items. Optionally, processor 101 computes the plurality of predicted scores by prediction model 110, optionally in response to the training user profile and the plurality of training items. Optionally, each of the plurality of training items has a plurality of training item properties, for example training item properties 122. Some examples of a training item are a restaurant identifier, a hospitality facility identifier, a movie identifier, a book identifier, a consumer appliance identifier, a retailer identifier, and a venue identifier. Some examples of a hospitality facility are a hotel, a bed & breakfast facility and a guest room. Some examples of a venue are a movie theater, a park, and a beach. Some examples of a training item property are a genre, a price range, and a location. Optionally, in 209 processor 101 computes for the training user profile a plurality of expected scores, each computed for one of the plurality of training items according to the plurality of training user attribute values and the plurality of training item properties of the training item. Optionally, processor 101 uses one or more software object 111 to compute the plurality of expected scores. Optionally, computing the plurality of expected scores comprises applying one or more content-based filtering methods to the plurality of training user attribute values and a plurality of training item properties of the plurality of training items. Optionally, one or more software object 111 comprises one or more other neural networks and applying the content-based filtering method comprises providing the plurality of training user attribute values and the plurality of training item properties to the one or more other neural networks. In 215, processor 101 optionally modifies one or more model values of a plurality of model values of prediction model 110 to maximize a reward score. Optionally, the reward score is computed using the plurality of expected scores and the plurality of predicted scores. Optionally, processor 101 executes 201, 205, 209 and 215 in each of a plurality of training iterations.

Optionally, 201, 205, 209 and 215 are executed while processor 101 executes a Q-learning method to train the prediction model, maximizing an expected value of a total reward over any and all successive actions, starting from an identified state. Optionally, the Q-learning method has a state. Optionally the state is a vector of state values indicative of plurality of training attribute values 122. Optionally, the Q-learning method has a schema, optionally comprising a template for creating the vector of state values such that the vector of state values is indicative of plurality of training user attribute values 121. Optionally, the vector of state values is a vector of numerical values. Optionally, creating the vector of state values comprises converting an object in an identified format, for example JavaScript Object Notation (JSON), to a vector of numerical values. Optionally, in 201 receiving the training user profile comprises creating the vector of state values. Optionally, in 201 receiving the training user profile comprises receiving the vector of state values. Optionally, the Q-learning method has a plurality of actions. Optionally, the plurality of actions is a plurality of vectors of item values. Optionally, each vector of item values is indicative of a respective plurality of training item properties of one of the plurality of training items, from plurality of training item properties 122. Optionally, the schema comprises another template for creating the vector of item values such that the vector of item values is indicative of some of plurality of training item values 122. Optionally, the vector of item values is another vector of numerical values. Optionally, creating the vector of item values comprises converting another object in an identified format, for example JavaScript Object Notation (JSON), to another vector of numerical values. In such embodiments, prediction model 110 may be trained to identify one or more items having a highest score for the user. Optionally, the Q-learning method has a reward. Optionally, the reward is the plurality of expected scores computed in 209. Optionally, the Q-learning method has an output. Optionally, the output is the plurality of predicted scores, computed in 205 in one of the plurality of training iterations. Optionally, in 205 processor 101 provides prediction model 110 with the vector of state values and the plurality of vectors of item values.

Alternatively, the state may be a vector of state values indicative of plurality of training attribute values 122 and plurality of item properties 121. Optionally, the schema comprises a template for creating the vector of state values such that the vector of state values is indicative of plurality of training user attribute values 121 and plurality of item properties 122. In such embodiments, the reward may be one of the plurality of expected scores computed in 209, for example a highest score computed in 209. Optionally, the output is a predicted score computed in 205 for one of the plurality of training user profiles and one of the plurality of training items in at least one of the plurality of iterations.

Optionally, in 220 processor 101 collects one or more feedback values from one of more training users associated with at least one of the plurality of training user profiles. Optionally, the one or more feedback values is indicative of a level of agreement of the one or more users with at least some of the plurality of predicted scores computed by the prediction model in 205 in at least one of the plurality of training iterations. Optionally, in 221, processor 101 updates one or more training user attributes values of plurality of training user attribute values 121 of the respective one or more training user profiles, according to the one or more feedback values. Optionally, processor 101 executes 220 and 221 in one or more of the plurality of training iterations.

According to some embodiments of the present invention, prediction model 110 is used to predict one or more scores for one or more items.

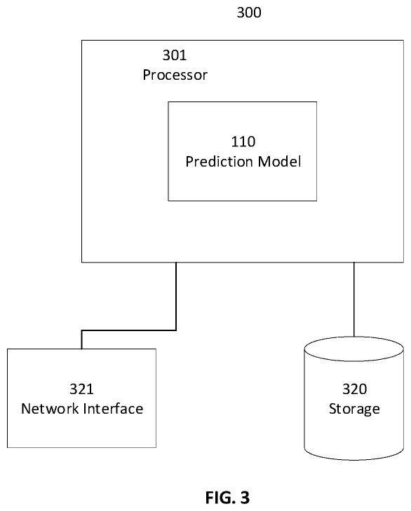

Reference is now made also to FIG. 3, showing a schematic block diagram of an exemplary system 300 for predicting, according to some embodiments of the present invention. In such embodiments processor 301 executes prediction model 110. Optionally, prediction model 110 is trained using system 100 implementing method 200. Optionally, processor 301 is connected to one or more non-volatile digital storage 320, optionally for the purpose of storing a plurality of item properties of a plurality of items. Optionally, one or more user profiles are stored on one or more non-volatile digital storage 320. Some examples of a non-volatile digital storage are a hard disk drive, a network storage and a storage network. Optionally, processor 301 is connected to one or more digital communication network interface 321. Optionally, processor 301 outputs the one or more scores via one or more digital communication network interface 321. Optionally, processor 301 receives the one or more user profiles via one or more digital communication network interface 321. Optionally, one or more digital communication network interface 321 is connected to a local area network, for example a wireless local area network or an Ethernet local area network. Optionally, one or more digital communication network interface 321 is connected to a wide area network, for example the Internet.

To predict the one or more scores for the one or more items, in some embodiments of the present invention system 300 implements the following optional method.

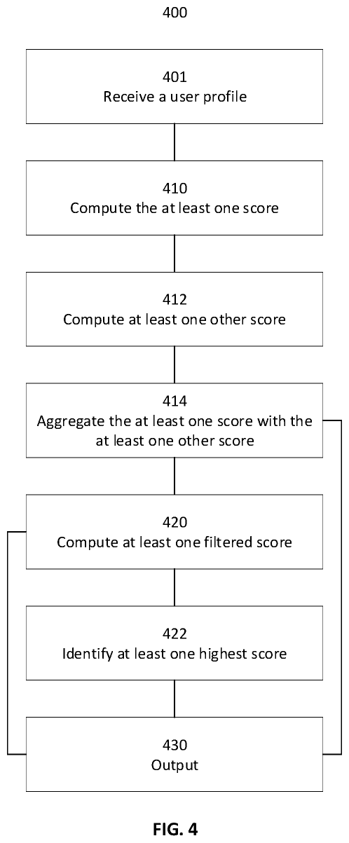

Reference is now made to FIG. 4, showing a flowchart schematically representing an optional flow of operations 400 for predicting, according to some embodiments of the present invention. In such embodiments, in at least one iteration of a plurality of iterations, in 401 processor 301 receives a user profile. Optionally, the user profile has a plurality of user attribute values. Optionally, at least one of the plurality of user attribute values is selected from a group of user attribute values comprising: a user demographic value, a user preference value, a historical interaction value, and a user identifier value. Optionally, processor 301 receives the user profile via one or more digital communication network interface 321. Optionally, processor 301 receives the user profile by reading the user profile from one or more non-volatile digital storage 320. In 410, processor 301 optionally computes one or more scores according to a similarity between the user profile and a plurality of other user profiles. Optionally, processor 301 computes the one or more scores by inputting the user profile and a plurality of items into prediction model 110. Optionally, one or more of the plurality of items is selected from a group of items comprising: a restaurant identifier, a hospitality facility identifier, a movie identifier, a book identifier, a consumer appliance identifier, a retailer identifier, and a venue identifier. Some examples of an item property are a genre, a price range, and a location. Optionally, the similarity between the user profile and the plurality of other user profiles is computed according to a similarity between the plurality of user attribute values and another plurality of user attribute values of the plurality of other user profiles. Optionally, inputting the user profile and a plurality of items into prediction model 110 comprises computing one or more sets of state values indicative of the plurality of user attributes and a plurality of item properties of the plurality of items. Optionally the one or more sets of state values are one or more sets of numerical values. In 430, processor 301 optionally outputs the one or more scores. Optionally, outputting the one or more scores comprises outputting a ranked list of scores, such that processor 301 outputs for each of the one or more scores a respective item of the one or more items. Optionally, in 430 processor 301 outputs the one or more scores via one or more digital communication network interface 321.

Optionally, processor 301 computes in 412 one or more other scores. Optionally each of the one or more other scores are computed for one of the plurality of items, optionally according to the plurality of user attribute values and the respective plurality of item properties of the respective items. Optionally, computing the one or more other scores comprises applying a content-based filtering method to the plurality of user attribute values and a plurality of item properties of the plurality of items. Optionally, computing the one or more other scores comprises computing one or more collaborative-filtering scores. Optionally, each of the one or more collaborative-filtering scores is computed for one of the plurality of items according to another similarity between the plurality of user attribute values and the other plurality of user attribute values of the other plurality of user profiles. Optionally, the one or more collaborative-filtering scores are computed by applying at least one matrix factorization method to the plurality of item properties, the plurality of user attribute values and the other plurality of user attribute values. In 414, processor 301 optionally aggregates the one or more other scores with the one or more scores. Optionally, processor 301 outputs in 430 the one or more scores computed in 414. Optionally, in 420 processor 301 computes one or more filtered scores by applying one or more tests to the one or more scores. Optionally, processor 301 applies the one or more tests to the one or more scores computed in 410. Optionally, processor applies the one or more tests to the one or more scores computed in 414. Optionally, the one or more tests apply one or more business constraints to the one or more items. For example, a test may restrict location of an item. Other examples of a test are a dietary restriction, a price range, an age classification, and availability of an item by a date. Optionally, in 430 processor 301 outputs the one or more filtered scores. Optionally, in 422 processor 301 identifies one or more highest scores of the one or more scores. Processor 301 may identify one highest score. Optionally, processor 301 identifies an identified amount of highest scores, for example 3, 10 or 28. Optionally, processor 301 outputs in 430 the one or more highest scores.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant prediction models will be developed and the scope of the term prediction model is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method for predicting at least one score for at least one item, comprising:
in at least one iteration of a plurality of iterations:
receiving a user profile having a plurality of user attribute values;
computing the at least one score according to a similarity between the user profile and a plurality of other user profiles by inputting the user profile and a plurality of items into a prediction model trained by:
in each of a plurality of training iterations:
receiving a training user profile of a plurality of training user profiles, the training user profile having a plurality of training user attribute values;
computing by the prediction model a plurality of predicted scores, each for one of a plurality of training items, in response to the training user profile and the plurality of training items, where each of the plurality of training items has a plurality of training item properties;
computing for the training user profile a plurality of expected scores, each computed for one of the plurality of training items according to the plurality of training user attribute values and the plurality of training item properties of the training item; and
modifying at least one model value of a plurality of model values of the prediction model to maximize a reward score computed using the plurality of expected scores and the plurality of predicted scores; and
outputting the at least one score.

2. The method of claim 1, wherein the similarity between the user profile and the plurality of other user profiles is computed according to a similarity between the plurality of user attribute values and another plurality of user attribute values of the plurality of other user profiles;
wherein the plurality of user attribute values comprises at least one of: a user demographic value, a user preference value, a user identifier value, and a historical user interaction value; and
wherein the historical user interaction value is indicative of a user interaction selected from a group of user interactions consisting of: a numerical score assigned by a user, a like indication, a purchase, a bookmarked item, and a skipped item.

3. The method of claim 1, wherein the prediction model comprises at least one deep reinforcement learning (DRL) network.

4. The method of claim 1, wherein computing the plurality of expected scores comprises applying a content based filtering method to the plurality of training user attribute values and a plurality of training item properties of the plurality of training items.

5. The method of claim 4, wherein applying the content based filtering method comprises providing the plurality of training user attribute values and the plurality of training item properties to at least one neural network.

6. The method of claim 1, wherein training the prediction model comprises using a Q-learning method having a state, a plurality of actions, a reward and an output;
wherein the state is a vector of state values indicative of a plurality of training user attribute values of the training user profile;
wherein the plurality of actions is a plurality of vectors of item values, each vector of item values indicative of a respective plurality of training item properties of one of the plurality of training items;
wherein the reward is the plurality of expected scores; and
wherein the output is the plurality of predicted scores.

7. The method of claim 1, wherein training the prediction model comprises using a Q-learning method having another state, another plurality of actions, another reward and another output;
wherein the other state is a vector of state values indicative of another plurality of training user attribute values of the training user profile and another plurality of training item properties of the plurality of training items;
wherein the plurality of actions is another plurality of vectors of item values, each vector of item values indicative of a respective plurality of training item properties of one of the plurality of training items;
wherein the reward is one of the plurality of expected scores; and
wherein the output is a predicted score computed for one of the plurality of training user profiles and one of the plurality of training items in at least one of the plurality of training iterations.

8. The method of claim 1, wherein training the prediction model further comprises:
collecting at least one feedback value from at least one training user associated with at least one of the plurality of training user profiles, where the at least one feedback value is indicative of a level of agreement of the at least one user with at least some of the plurality of predicted scores computed by the prediction model in response to the respective training user profile and the plurality of training items; and
updating at least one training user attribute value of the respective at least one training user profile according to the at least one feedback value.

9. The method of claim 1, wherein at least one of the plurality of items is selected from a group of items consisting of: a restaurant identifier, a hospitality facility identifier, a movie identifier, a book identifier, a consumer appliance identifier, a retailer identifier, and a venue identifier.

10. The method of claim 1, wherein outputting the at least one score comprises outputting for each of the at least one score a respective item of the at least one item.

11. The method of claim 1, wherein inputting the user profile and the plurality of items into a prediction model comprises computing at least one set of state values indicative of the plurality of user attribute values and a plurality of item properties of the plurality of items.

12. The method of claim 1, wherein computing the at least one score further comprises:
computing at least one other score, each computed for one of the plurality of items according to the plurality of user attribute values and the respective plurality of item properties of the respective item; and
aggregating the at least one score with the at least one other score.

13. The method of claim 12, wherein computing the at least one other score comprises applying a content based filtering method to the plurality of user attribute values and a plurality of item properties of the plurality of items.

14. The method of claim 1, wherein computing the at least one score further comprises:
identifying at least one highest score of the at least one score; and
outputting the at least one highest score.

15. The method of claim 1, wherein computing the at least one score further comprises:
computing at least one filtered score by applying at least one test to the at least one score; and
outputting the at least one filtered score.

16. The method of claim 2, wherein computing the at least one score further comprises:
computing at least one collaborative filtering score, each computed for one of the plurality of items according to another similarity between the plurality of user attribute values and the other plurality of user attribute values of the plurality of other user profiles, by applying at least one matrix factorization method to the plurality of item properties, the plurality of user attribute values and the other plurality of user attribute values; and
aggregating the at least one score with the at least one collaborative filtering score.

17. A system for predicting at least one score for at least one item, comprising at least one hardware processor adapted to:
in at least one iteration of a plurality of iterations:
receiving a user profile having a plurality of user attribute values;
computing the at least one score according to a similarity between the user profile and a plurality of other user profiles by inputting the user profile and a plurality of items into a prediction model trained by:
in each of a plurality of training iterations:
receiving a training user profile of a plurality of training user profiles, the training user profile having a plurality of training user attribute values;
computing by the prediction model a plurality of predicted scores, each for one of a plurality of training items, in response to the training user profile and the plurality of training items, where each of the plurality of training items has a plurality of training item properties;
computing for the training user profile a plurality of expected scores, each computed for one of the plurality of training items according to the plurality of training user attribute values and the plurality of training item properties of the training item; and
modifying at least one model value of a plurality of model values of the prediction model to maximize a reward score computed using the plurality of expected scores and the plurality of predicted scores; and
outputting the at least one score.

18. The system of claim 17, wherein the at least one hardware processor is adapted to outputting the at least one score via at least one digital communication network interface connected to the at least one hardware processor.

19. The system of claim 17, wherein the at least one hardware processor is adapted to receiving the user profile by at least one of: receiving the user profile via at least one digital communication network interface connected to the at least one hardware processor, and retrieving the user profile from at least one non-volatile digital storage connected to the at least one hardware processor.

20. A system for training a prediction model, comprising at least one hardware processor adapted to:
in each of a plurality of training iterations:
receiving a training user profile of a plurality of training user profiles, the training user profile having a plurality of training user attribute values;
computing by the prediction model a plurality of predicted scores, each for one of a plurality of training items, in response to the training user profile and the plurality of training items, where each of the plurality of training items has a plurality of training item properties;
computing for the training user profile a plurality of expected scores, each computed for one of the plurality of training items according to the plurality of training user attribute values and the plurality of training item properties of the training item; and
modifying at least one model value of a plurality of model values of the prediction model to maximize a reward score computed using the plurality of expected scores and the plurality of predicted scores.
